(19) United States
(12) Patent Application Publication
(10) Pub. No.: US 2017/0004758 A1
(43) Pub. Date: Jan. 5, 2017

(54) DISPLAY DEVICE

(71) Applicant: SAMSUNG DISPLAY CO., LTD., YONGIN-SI (KR)

(72) Inventors: HO SEOK SON, ANYANG-SI (KR); TAE JIN KIM, BUCHEON-SI (KR); SOO-WAN YOON, HWASEONG-SI (KR); MYUNG HO LEE, ANYANG-SI (KR)

(21) Appl. No.: 15/063,918

(22) Filed: Mar. 8, 2016

(30) Foreign Application Priority Data
Jul. 2, 2015 (KR) 10-2015-0094871

(51) Int. Cl. G09G 3/20; G09G 3/36; G09G 3/3233

(52) U.S. Cl. CPC G09G 3/2092; G09G 3/3233; G09G 3/3648; G09G 2310/0202; G09G 2310/0267; G09G 2310/027

(57) ABSTRACT

A display device includes: a substrate; a plurality of first signal lines formed to extend in a first direction on the substrate; and a plurality of second signal lines formed to extend in a second direction crossing the first direction and connected to the plurality of first signal lines, wherein wire widths of the first signal lines are formed to be different according to a length of the connected second signal lines.

### RELATED APPLICATIONS

This application claims priority to and the benefit of Korean Patent Application No. 10-2015-0094871 filed on Jul. 2, 2015, the entire contents of which are herein incorporated by reference.

### TECHNICAL FIELD

Exemplary embodiments relate to a display device. More particularly, they relate to a display device with an improved display quality.

### DESCRIPTION OF RELATED ART

A display device includes a liquid crystal display (LCD), a plasma display panel (PDP), an organic light emitting device, and an electrophoretic display device (EPD).

A plurality of pixels and a plurality of signal lines are formed on a display panel of the display device. A plurality of pixels have been integrated in a narrow display area according to an increasing resolution of the display device. To use the above-noted display panel and provide a wider screen to a user, an area of a display area of a display panel may be increased, and an area of a bezel in which a driving circuit is formed on a circumference of the display area may be reduced.

The area of the bezel on an edge of the display panel may be reduced to increase a size of the display area in which the image is displayed relative to the size of the display panel. A scan driver or a gate driver may be disposed on right and left edges of the display panel so it is difficult to realize a narrow bezel.

### SUMMARY

According to an exemplary embodiment provides a display device including: a substrate, a plurality of first signal lines extend in a first direction on the substrate, and a plurality of second signal lines formed to extend in a second direction crossing the first direction. Each first signal line of the plurality of first signal lines is connected to the respective second signal line of the plurality of second signal lines, wherein wire widths of the first signal lines increase based on a length of the connected second signal line.

In an exemplary embodiment wire widths of the first signal lines may be increased when the connected second signal line becomes longer.

In an exemplary embodiment wire widths of the second signal lines may be increased when the second signal lines become longer.

In an exemplary embodiment wire widths of the first signal lines and the second signal lines may be between 2.5 μm and 5.5 μm.

In an exemplary embodiment the display device may further include a scan driver formed on a first side of the substrate and connected to the second signal lines and the scan driver supplies a scan signal to the second signal lines.

In an exemplary embodiment each second signal line of the plurality of second signal lines may be connected to a different first signal line from among the plurality of first signal lines and the length of each second signal line of the plurality of second signal lines is the distance from the scan driver to the respective connected first signal line from among the plurality of first signal lines.

In an exemplary embodiment the first signal lines and the second signal lines may be formed on a layer.

In an exemplary embodiment the display device may further include a plurality of third signal lines extend in the second direction on the substrate, a data driver formed on the first side and connected to the third signal lines and the data driver supplies a data signal to the third signal lines.

In an exemplary embodiment the display device may further include each pixel of a plurality of pixels connected to the first signal line of the plurality of first signal lines and the third signal line of the plurality of the third signal lines.

According to an exemplary embodiment a display device includes a display panel, a scan driver on a side of the display panel, a plurality of first signal lines in a first direction, wherein a first end of each of the plurality of first signal lines are connected to the scan driver and a plurality of second signal lines in a second direction, wherein each second signal line of the plurality of second signal lines connected to a respective second end of each of the plurality of first signal lines. The wire width of each of the plurality of first signal lines increases based on the respective length of each of the plurality of first signal lines.

In an exemplary embodiment the first direction and the second direction are perpendicular.

In an exemplary embodiment the length of each of the plurality of first signal lines is the distance from the scan driver to the respective connected first signal line from among the plurality of first signal lines.

In an exemplary embodiment the display device includes a data driver, and a plurality of data lines connected to the data driver arranged along the second direction.

In an exemplary embodiment the display device includes a plurality of pixels, wherein each pixel is connected to a respective second signal line and a data line.

According to an exemplary embodiment a display device includes a display panel, a scan driver on a side of the display panel, a plurality of first signal lines in a first direction, wherein a first end of each of the plurality of first signal lines are connected to the scan driver and a plurality of second signal lines in a second direction, wherein each second signal line of the plurality of second signal lines connected to a respective second end of each of the plurality of first signal lines. The wire width of each of the plurality of second signal lines increases based on the respective length of each of the plurality of first signal lines.

In an exemplary embodiment the first direction and the second direction are perpendicular.

In an exemplary embodiment the length of each of the plurality of first signal lines is the distance from the scan driver to the respective connected first signal line from among the plurality of first signal lines.

In an exemplary embodiment the display device includes a data driver and a plurality of data lines connected to the data driver arranged along the second direction.

In an exemplary embodiment the display device includes a plurality of pixels. wherein each pixel is connected to a respective second signal line and a data line.

### BRIEF DESCRIPTION OF THE DRAWINGS

FIG. 1 shows a block diagram of a display device according to a first exemplary embodiment.

FIG. 2 shows a top plan view of part of a display unit according to a first example of a first exemplary embodiment.

FIG. 3 shows a top plan view of part of a display unit according to a second example of a first exemplary embodiment.

FIG. 4 shows a block diagram of a display device according to a second exemplary embodiment.

FIG. 5 shows a top plan view of part of a display unit according to a first example of a second exemplary embodiment.

FIG. 6 shows a top plan view of part of a display unit according to a second example of a second exemplary embodiment.

### DETAILED DESCRIPTION

Hereinafter, exemplary embodiments disclosed in the present specification will be described in detail with reference to the accompanying drawings. In the present specification, the same or similar components will be denoted by the same or similar reference numerals, and an overlapped description thereof will be omitted.

Terms including ordinal numbers such as first, second, and the like, will be used only to describe various components, and are not interpreted as limiting these components. The terms are only used to differentiate one component from other components.

It is to be understood that when one component is referred to as being “connected” or “coupled” to another component, it may be connected or coupled directly to another component or be connected or coupled to another component with the other component intervening therebetween. On the other hand, it is to be understood that when one component is referred to as being “connected or coupled directly” to another component, it may be connected or coupled to another component without the other component intervening therebetween.

Singular forms are to include plural forms unless the context clearly indicates otherwise.

The display device according to an exemplary embodiment may be applied to various electronic devices, such as a digital TV, a desktop computer, digital signage, a mobile phone, a smart phone, a laptop computer, a digital broadcasting terminal, a personal digital assistant (PDA), a portable multimedia player (PMP), a navigation device, a slate PC, a tablet PC, an ultrabook, a wearable device, for example, a watch-type terminal (a smartwatch), a glass terminal (a smart glass), and a head mounted display (HMD).

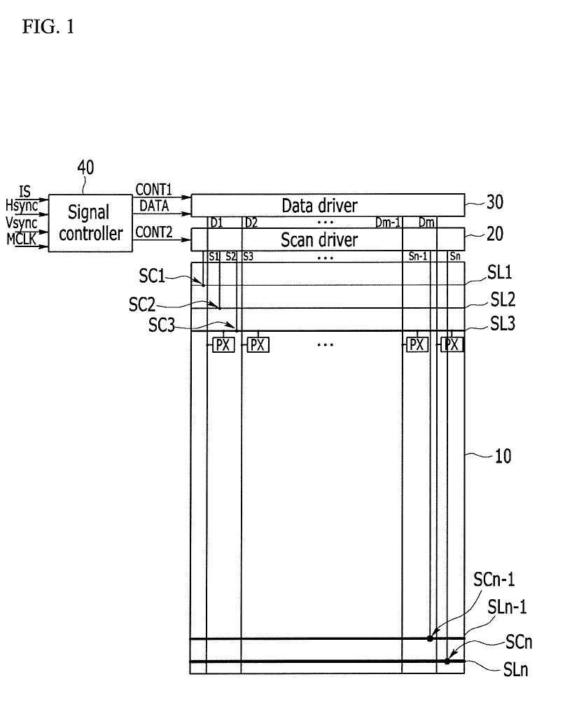

FIG. 1 shows a block diagram of a display device according to a first exemplary embodiment.

The display device includes a display unit 10, a scan driver 20, a data driver 30, and a signal controller 40. The components illustrated in FIG. 1 are not to scale, thus the display device described in the present specification may include a larger or smaller number of components than those described above.

The display unit 10 is a display panel including a plurality of pixels PX connected to a corresponding horizontal scan line from among a plurality of horizontal scan lines (SL1 to SLn) and a corresponding data line from among a plurality of data lines (D1 to Dm). The pixels PX respectively display an image according to a data signal transmitted to a corresponding pixel. Further, power supply voltages are supplied to the pixel PX from a power supply circuit.

A plurality of pixels PX included in the display unit 10 are connected to a plurality of horizontal scan lines (SL1 to SLn) and a plurality of data lines (D1 to Dm) and are arranged in a matrix form.

A plurality of horizontal scan lines (SL1 to SLn) extend in a horizontal direction and the horizontal scan lines (SL1 to SLn) are substantially parallel with each other. The width of the wire for each of the plurality of horizontal scan lines (e.g. SLn) is wider than the previous horizontal scan lines (e.g. SLn−1) along the vertical direction. Each individual horizontal scan line has a consistent wire width. For example, a first horizontal scan line SL1 to an n-th substantially horizontal scan line (SLn) extend in the horizontal direction and they are substantially parallel with each other.

A plurality of horizontal scan lines (SL1 to SLn) are formed so that a wire width from the first horizontal scan line SL1 to the n-th substantially horizontal scan line (SLn) may increase compared to the previous horizontal scan line. For example, a wire width of the first horizontal scan line SL1 is formed to be about 2.5 μm. A wire thickness of the horizontal scan lines (SL2 to SLn−1) is formed to be gradually increased according to a distance from the scan driver 20, and a wire width of the n-th horizontal scan line (SLn) is formed to be about 5.5 μm.

A plurality of vertical scan lines (S1 to Sn) extend in the vertical direction and are parallel with each other. The horizontal scan lines (SL1 to SLn) are connected to a corresponding vertical scan line from among a plurality of vertical scan lines (S1 to Sn). A plurality of horizontal scan lines (SL1 to SLn) and a plurality of vertical scan lines (S1 to Sn) may be formed on a single layer.

A plurality of vertical scan lines (S1 to Sn) are connected to a corresponding horizontal scan line through a corresponding connection point from among a plurality of connection points (SC1 to SCn). For example, the first horizontal scan line SL1 is connected to the first vertical scan line S1 through the first connection point SC1. A plurality of connection points (SC1 to SCn) may be formed on a single layer as a plurality of horizontal scan lines (SL1 to SLn) and a plurality of vertical scan lines (S1 to Sn).

Here, the vertical scan line connected to at least one horizontal scan line may not extend for the length of the display panel. For example, the first vertical scan line S1 connected to the first horizontal scan line SL1 does not substantially extend past the first vertical scan line S1 and stops before the second horizontal scan line SL2. A vertical scan line connected to at least one horizontal scan line may extend in the vertical direction. The horizontal scan lines (SL1 to SLn) and the vertical scan lines (S1 to Sn) are formed in directions such that they cross each other and are substantially perpendicular.

A width of the horizontal scan lines may be changed according to a length of the connected vertical scan line. For example, when the vertical scan lines extending from the scan driver 20 becomes longer, wire resistance and parasitic resistance are increased so the scan signal transmitted to the horizontal scan lines may be delayed. Therefore, the wire width of the horizontal scan lines (SLn−1, SLn) connected to the long vertical scan lines (Sn−1, Sn) is greater than the wire width of the horizontal scan lines SL1, SL2, and SL3 connected to the short vertical scan lines S1, S2, and S3.

A plurality of data lines (D1-Dm) substantially extend in the vertical direction and are substantially horizontal.

The scan driver 20 is connected to the display unit 10 through a plurality of vertical scan lines (S1-Sn). The scan driver 20 generates a plurality of scan signals according to a control signal CONT2 and transmits the scan signals to a corresponding vertical scan line from among a plurality of vertical scan lines (S1-Sn). The scan signal transmitted by the scan driver 20 may be applied to horizontal scan lines (SL1-SLn) through the vertical scan lines (S1-Sn). For example, the scan signal is applied to the first horizontal scan line SL1 through the first vertical scan line S1 connected to the first horizontal scan line SL1.

The control signal CONT2 is an operation control signal on the scan driver 20 generated and transmitted by the signal controller 40. The control signal CONT2 may include a scan start signal and different types of clock signals. The scan start signal is a signal for generating a first scan signal for displaying a one-frame image. One of the clock signals is a synchronization signal for sequentially applying a scan signal to a plurality of vertical scan lines (S1-Sn).

The data driver 30 is connected to respective pixels PX of the display unit 10 through a plurality of data lines (D1-Dm). The data driver 30 receives an image data signal (DATA) and transmits a data signal to a corresponding data line from among a plurality of data lines (D1-Dm) according to the control signal CONT1.

The control signal CONT1 is an operation control signal on the data driver 30 generated and transmitted by the signal controller 40.

The data driver 30 selects a gray voltage according to the image data signal (DATA) and transmits the image data signal as a data signal to a plurality of data lines (D1-Dm). In detail, the data driver 30 samples and holds the image data signal (DATA) that is input according to the control signal CONT1, and transmits a plurality of data signals to a plurality of data lines (D1-Dm). For example, the data driver 30 may apply a data signal with a predetermined voltage range to a plurality of data lines (D1-Dm) in response to a scan signal with a gate-on voltage.

The scan driver 20 and the data driver 30 may be disposed on a first side of the display unit 10. For example, the scan driver 20 and the data driver 30 may be disposed on an upper side of the display unit 10. In an exemplary embodiment, the scan driver 20 may be disposed on a first side of the display unit 10, and the data driver 30 may be disposed on a second side on which the scan driver 20 is not disposed.

In an exemplary embodiment, the driving circuit does not need to be bonded to or installed in the right or left bezel regions of the display unit 10. Therefore, the exemplary embodiment may reduce the widths of the right and left bezel regions of the display unit 10.

The signal controller 40 receives an image signal (IS) and the input control signals for controlling displaying of the image signal. The image signal (IS) may include luminance information classified by respective grays of the pixels PX of the display unit 10.

Examples of the input control signals transmitted to the signal controller 40 include a vertical synchronization signal Vsync, a horizontal synchronizing signal Hsync, and a main clock signal MCLK.

The signal controller 40 generates control signals (CONT1, CONT2) and image data signals (DATA) according to the image signal (IS), the horizontal synchronizing signal Hsync, the vertical synchronization signal Vsync, and the main clock signal MCLK.

The signal controller 40 processes the image signal (IS) according to operating conditions of the display unit 10 and the data driver 30 based upon the input image signal (IS) and the input control signals. For example, the signal controller 40 may generate the image data signal (DATA) by undergoing image processing such as gamma correction or luminance compensation on the image signal (IS).

For example, the signal controller 40 generates a control signal CONT1 for controlling the data driver 30, and transmits the control signal CONT1 to the data driver 30 together with the image-processed image data signal (DATA). The signal controller 40 transmits the control signal CONT2 for controlling the scan driver 20 to the scan driver 20.

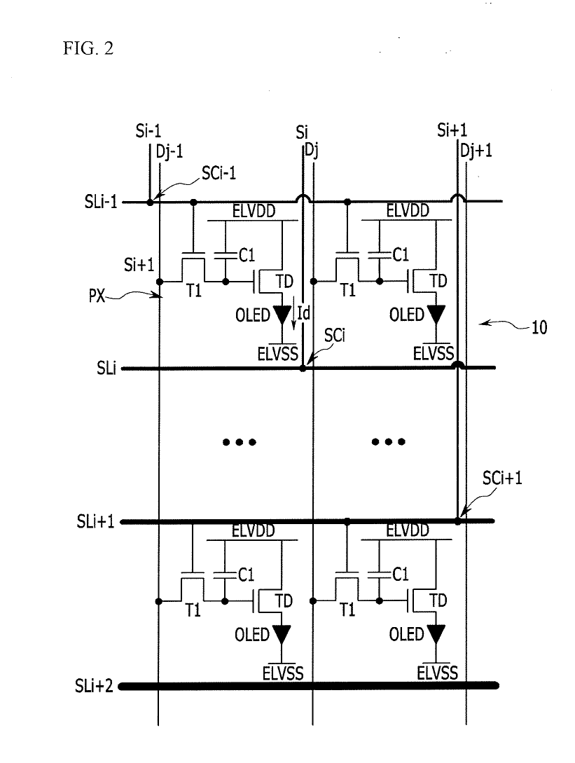

FIG. 2 shows a wire diagram of part of a display unit 10 according to a first example of a first exemplary embodiment. As shown, the display unit 10 includes a plurality of pixels PX connected to a plurality of signal lines. A plurality of pixels PX may have a pixel configuration for emitting light to an organic light emitting diode (OLED). It will be described in FIG. 2 that the display device is an organic light emitting device for emitting light using an organic light emitting diode.

Each pixel may include a plurality of transistors, capacitors, and organic light emitting diodes. The transistors may include a driving transistor (TD) and a switching transistor T1. The transistors may be formed with one of an amorphous silicon thin film transistor (amorphous-S1 TFT), a low temperature poly-silicon (LTPS) thin film transistor, and an oxide thin film transistor (oxide TFT). The oxide thin film transistor (oxide TFT) may have an oxide such as an indium-gallium-zinc-oxide (IGZO), a zinc oxide (ZnO), and a titanium oxide (TiO) as a semiconductor layer.

The signal line includes horizontal scan lines (SLi−1 to SLi+2) for transmitting a scan signal to the pixel, vertical scan lines (Si−1 to Si+1) for transmitting a scan signal to the horizontal scan lines (SLi−1 to SLi+2), and data lines (Dj−1 to Dj+1) crossing the horizontal scan line and transmitting a data signal.

The vertical scan lines (Si−1 to Si+1) are connected to the horizontal scan lines (SLi−1 to SLi+2) through a corresponding connection point from among a plurality of connection points (SCi−1, SCi, and SCi+1).

The horizontal scan lines (SLi−1 to SLi+2) may be formed to have a substantially increasing width as the distance from the scan driver 20 increases. For example, a width of the i-th horizontal scan line (SLi) is formed to be greater than a width of the (i−1)-th horizontal scan line (SLi−1). A width of the (i+1)-th horizontal scan line (SLi+1) is formed to be greater than a width of the i-th horizontal scan line (SLi). The wire width of the horizontal scan line increases as the distance from the scan driver 20 increases and minimizes the RC delay since the scan signal transmitted through the vertical scan lines (Si−1 to Si+1) is reduced by resistance of the vertical scan lines (Si−1 to Si+1).

In detail, regarding the pixel PX connected to the (i−1)-th horizontal scan line (SLi−1), the driving transistor (TD) includes a gate connected to a first end of the capacitor C1, a source connected to a first power supply voltage (ELVDD), and a drain connected to an anode of the organic light emitting diode (OLED). The driving transistor (TD) receives a data signal (Data) according to a switching operation by the switching transistor T1 to supply a driving current (Id) to the organic light emitting diode (OLED).

The switching transistor T1 includes a gate connected to the horizontal scan line (SLi−1), a source connected to the data line Dj−1, and a drain connected to the gate of the driving transistor (TD) and a first end of the capacitor C1.

The switching transistor T1 is turned on by the scan signal transmitted through the horizontal scan line (SLi−1) to perform a switching operation for transmitting the data signal provided to the data line Dj−1 to the gate of the driving transistor (TD).

A second end of the capacitor C1 is connected to the first power supply voltage (ELVDD), and a cathode of the organic light emitting diode (OLED) is connected to the second power supply voltage (ELVSS). Accordingly, the organic light emitting diode (OLED) receives the driving current (Id) from the driving transistor (TD) to emit light so the organic light emitting device displays an image.

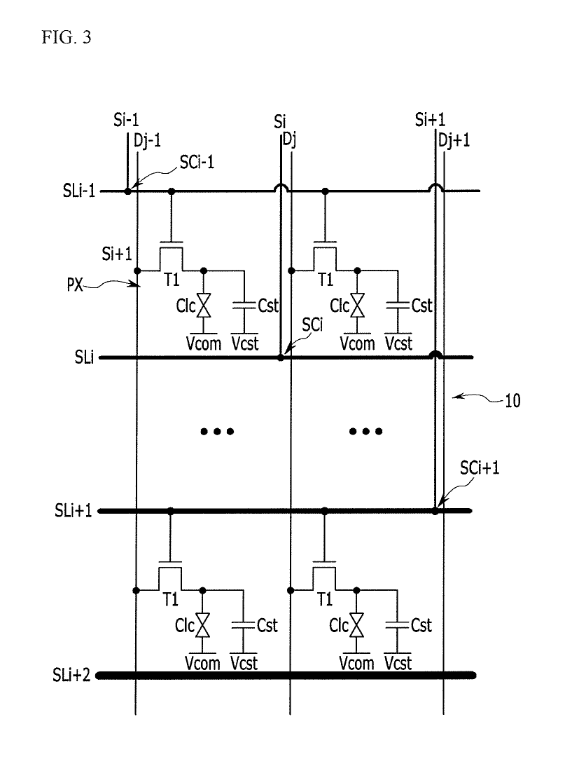

A second example of the first exemplary embodiment will now be described with reference to FIG. 3.

FIG. 3 shows a wire diagram of a display unit 10 according to a second example of a first exemplary embodiment. In FIG. 3, the display device will be described as a liquid crystal display that may be realized in a liquid crystal mode with a configuration known as a twisted nematic (TN) mode, a vertical alignment (VA) mode, an in-plane switching (IPS) mode, and a fringe field switching (FFS) mode.

As shown, the display unit 10 includes a plurality of pixels PX connected to a plurality of signal lines. Each pixel may include a switching transistor, a liquid crystal capacitor Clc, and a storage capacitor Cst.

The signal line includes horizontal scan lines (SLi−1 to SLi+2) for transmitting a scan signal to the pixel, vertical scan lines (Si−1 to Si+1) for transmitting a scan signal to the horizontal scan lines (SLi−1 to SLi+2), and data lines (Dj−1 to Dj+1) crossing the horizontal scan line and transmitting a data signal.

The vertical scan lines (Si−1 to Si+1) are connected to the horizontal scan line (SLi−1 to SLi+2) through a corresponding connection point from among a plurality of connection points (SCi−1, SCi, and SCi+1).

The horizontal scan lines (SLi−1 to SLi+2) may be formed to have a substantially increasing width as the distance from the scan driver 20 increases. For example, a width of the i-th horizontal scan line (SLi) is formed to be greater than a width of the (i−1)-th horizontal scan line (SLi−1). A width of the (i+1)-th horizontal scan line (SLi+1) is formed to be greater than a width of the i-th horizontal scan line (SLi). The wire width of the horizontal scan line increases as the distance from the scan driver 20 increases and minimizes the RC delay since the scan signal transmitted through the vertical scan lines (Si−1 to Si+1) is reduced by resistance of the vertical scan lines (Si−1 to Si+1).

For example, regarding the pixel PX connected to the (i−1)-th horizontal scan line (SLi−1), the switching transistor T1 includes a gate connected to the horizontal scan line (SLi−1), a source connected to the data line Dj−1, and a drain connected to a pixel electrode. For example, the drain may be connected to a first end of the liquid crystal capacitor Clc and a first end of the storage capacitor Cst.

The switching transistor T1 is turned on by the scan signal transmitted through the horizontal scan line (SLi−1) to perform a switching operation for transmitting the data signal provided to the data line Dj−1 to the liquid crystal capacitor Clc and the storage capacitor Cst.

A second-side terminal of the liquid crystal capacitor Clc may be connected to a common electrode to which a common voltage Vcom is applied, and a second-side terminal of the storage capacitor Cst may be connected to a storage electrode to which a storage voltage (Vcst) is applied.

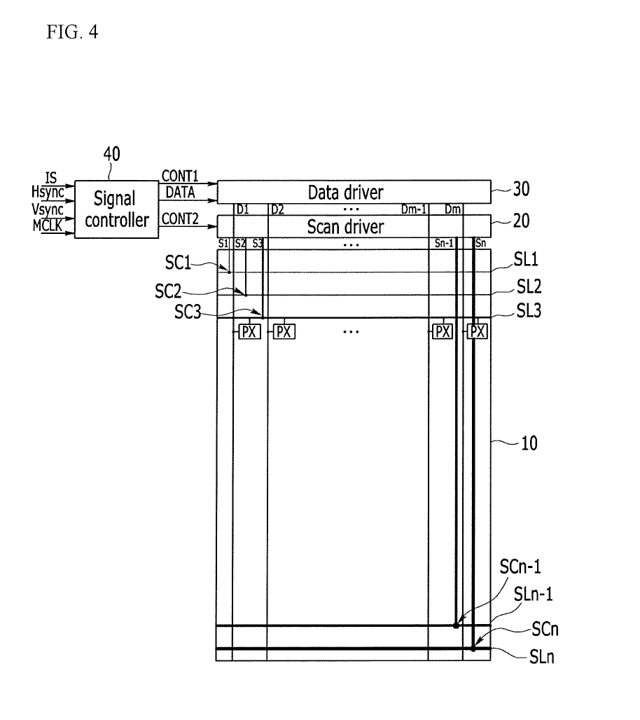

FIG. 4 shows a block diagram of a display device according to a second exemplary embodiment. A scan driver 20, a data driver 30, and a signal controller 40 of the display device according to a second exemplary embodiment generally correspond to the descriptions provided with reference to FIG. 1 so no detailed description will be provided.

The display unit 10 is a display panel including a plurality of pixels PX connected to a corresponding horizontal scan line from among a plurality of horizontal scan lines (SL1-SLn) and a corresponding data line from among a plurality of data lines (D1-Dm).

A plurality of horizontal scan lines (SL1 to SLn) extend in a vertical direction and the plurality of horizontal scan lines (SL1 to SLn) are substantially parallel with each other. The width of the wire for each of the plurality of horizontal scan lines (e.g. SLn) is wider than the previous horizontal scan lines (e.g. SLn−1) along the vertical direction. Each individual horizontal scan line has a consistent wire width. For example, a first horizontal scan line SL1 to an n-th horizontal scan line (SLn) extend in the horizontal direction and they are substantially parallel with each other. A plurality of horizontal scan lines (SL1 to SLn) are formed so that a wire width from the first horizontal scan line SL1 to the n-th substantially horizontal scan line (SLn) may be substantially increased. For example, a wire width of the first horizontal scan line SL1 is formed to be about 2.5 μm. A wire thickness of the horizontal scan lines (SL2 to SLn−1) is formed to be gradually increased according to a distance from the scan driver 20, and a wire width of the n-th substantially horizontal scan line (SLn) is formed to be about 5.5 μm.

A plurality of vertical scan lines (S1 to Sn) extend in the vertical direction and are substantially parallel with each other. The horizontal scan lines (SL1 to SLn) may be connected to a corresponding vertical scan line from among a plurality of vertical scan lines (S1 to Sn). A plurality of horizontal scan lines (SL1 to SLn) and a plurality of vertical scan lines (S1 to Sn) may be formed on a single layer.

A plurality of vertical scan lines (S1 to Sn) are connected to a corresponding horizontal scan line through a corresponding connection point from among a plurality of connection points (SC1 to SCn). For example, the first horizontal scan line SL1 is connected to the first vertical scan line S1 through the first connection point SC1. A plurality of connection points (SC1 to SCn) may be formed on a single layer as a plurality of horizontal scan lines (SL1 to SLn) and a plurality of vertical scan lines (S1 to Sn).

A width of the horizontal scan lines may be changed according to a length of the connected vertical scan line. For example, wire resistance and parasitic resistance are increased when the vertical scan line extending from the scan driver 20 becomes longer, and the scan signal transmitted to the horizontal scan line may be delayed. Therefore, the wire width of the horizontal scan lines (SLn−1, SLn) connected to the long vertical scan lines (Sn−1, Sn) is greater than the wire width of the horizontal scan lines SL1, SL2, and SL3 connected to the shorter vertical scan lines S1, S2, and S3.

Further, the wire width of the vertical scan line (S1 to Sn) increases based on the length of the vertical scan lines (S1 to Sn). For example, the n-th substantially vertical scan line (Sn) is longer than the first horizontal scan line SL1. The n-th substantially vertical scan line (Sn) is formed to be wider than the first vertical scan line S1. For example, a wire width of the first vertical scan line S1 is formed to be about 2.5 μm. When the length of wiring is increased, a wire thickness of the vertical scan line (S2-Sn−1) is formed to be increased, and the wire width of the n-th substantially vertical scan line (Sn) is formed to be about 5.5 μm.

In FIG. 4, the first horizontal scan line SL1 is connected to the first vertical scan line S1, and the n-th substantially horizontal scan line (SLn) is connected to the n-th substantially vertical scan line (Sn) so the width of the vertical scan line (S1-Sn) may be increased in the horizontal direction.

Further, the vertical scan line connected to at least one horizontal scan line may not extend for the length of the display panel. For example, the first vertical scan line S1 connected to the first horizontal scan line SL1 does not substantially extend past the first horizontal scan line SL1 and stops before the second horizontal scan line SL2. A vertical scan line connected to at least one horizontal scan line may extend in the vertical direction. The horizontal scan lines (SL1 to SLn) and the vertical scan lines (S1 to Sn) are formed in a direction in which they cross each other and are substantially perpendicular.

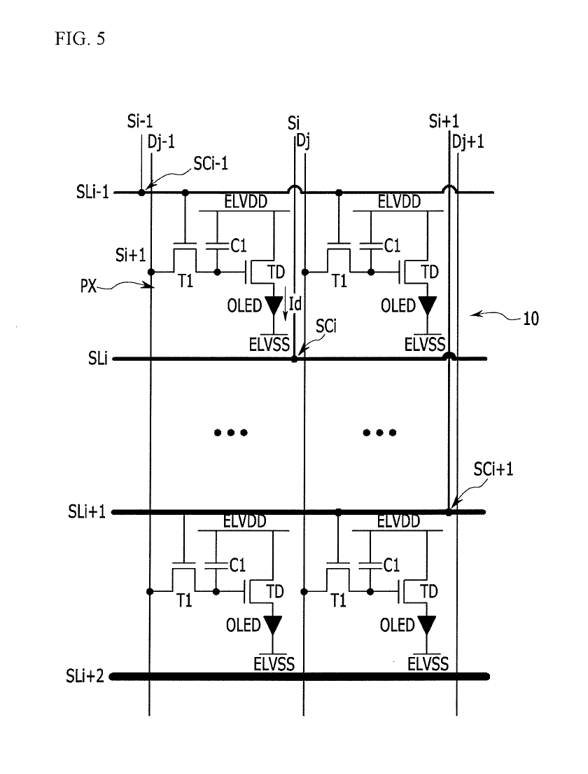

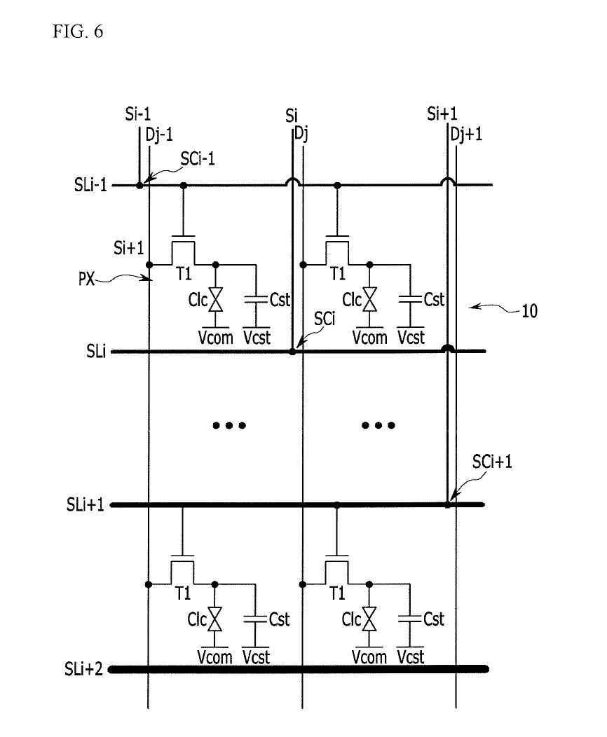

A display unit 10 according to a second exemplary embodiment will now be described with reference to FIG. 5 and FIG. 6.

FIG. 5 shows a wire diagram of a display unit 10 according to a first example of a second exemplary embodiment. A configuration of a pixel shown in FIG. 5 generally corresponds to the description provided with reference to FIG. 2 so no detailed description will be provided.

The signal line includes horizontal scan lines (SLi−1 to SLi+2) for transmitting a scan signal to the pixel, vertical scan lines (Si−1 to Si+1) for transmitting a scan signal to the horizontal scan lines (SLi−1 to SLi+2), and data lines (Dj−1 to Dj+1) crossing the horizontal scan line and transmitting a data signal.

The vertical scan lines (Si−1 to Si+1) are connected to the horizontal scan line (SLi−1 to SLi+2) through a corresponding connection point from among a plurality of connection points (SCi−1, SCi, and SCi+1).

The horizontal scan lines (SLi−1 to SLi+2) may be formed to have a substantially increasing width as the distance from the scan driver 20 increases. For example, a width of the i-th horizontal scan line (SLi) is formed to be greater than a width of the (i−1)-th horizontal scan line (SLi−1). A width of the (i+1)-th horizontal scan line (SLi+1) is formed to be greater than a width of the i-th horizontal scan line (SLi). The wire width of the horizontal scan line increases as the distance from the scan driver 20 increases and minimizes the RC delay since the scan signal transmitted through the vertical scan lines (Si−1 to Si+1) is reduced by resistance of the vertical scan lines (Si−1 to Si+1).

The vertical scan lines (Si−1 to Si+2) may be formed to have a substantially increasing width as the distance between the horizontal scan line and the scan driver 20 increases. As the vertical scan lines (Si−1 to Si+1) become longer, the wire width of the vertical scan lines (Si−1 to Si+1) is increased.

For example, a width of the i-th vertical scan line (Si) is formed to be greater than a width of the (i−1)-th vertical scan line (Si−1). A width of the (i+1)-th vertical scan line (Si+1) is formed to be greater than a width of the i-th vertical scan line (Si). The increased wire width of the vertical scan line connected to the horizontal scan line that is distant from the scan driver 20, reduces resistance, and minimizes the RC delay since the resistance of the vertical scan lines is reduced.

FIG. 6 shows a wire diagram of a display unit 10 according to a second example of a second exemplary embodiment.

A configuration of a pixel shown in FIG. 6 generally corresponds to the description provided with reference to FIG. 3 so no detailed description will be provided.

The signal line includes horizontal scan lines (SLi−1 to SLi+2) for transmitting a scan signal to the pixel, vertical scan lines (Si−1 to Si+1) for transmitting a scan signal to the horizontal scan lines (SLi−1 to SLi+2), and data lines (Dj−1 to Dj+1) crossing the horizontal scan line and transmitting a data signal.

The vertical scan lines (Si−1 to Si+1) are connected to the horizontal scan lines (SLi−1 to SLi+2) through a corresponding connection point from among a plurality of connection points (SCi−1, SCi, and SCi+1).

The horizontal scan lines (SLi−1 to SLi+2) may be formed to have a substantially increasing width as the distance from the scan driver 20 increases. When the vertical scan lines (Si−1 to Si+1) become longer, the wire width of the vertical scan lines (Si−1 to Si+1) is increased.

For example, a width of the i-th horizontal scan line (SLi) is greater than a width of the (i−1)-th horizontal scan line (SLi−1). A width of the (i+1)-th horizontal scan line (SLi+1) is greater than a width of the i-th horizontal scan line (SLi). This increases the wire width of the horizontal scan line that is distant from the scan driver 20 and minimizing the RC delay since the resistance of the vertical scan lines (Si−1 to Si+1) is reduced.

The vertical scan lines (Si−1 to Si+1) may be formed to have a substantially increasing width when connected to the horizontal scan line that is distant from the scan driver 20. For example, a width of the i-th vertical scan line (Si) is greater than a width of the (i−1)-th vertical scan line (Si−1). A width of the (i+1)-th vertical scan line (Si+1) is greater than a width of the i-th vertical scan line (Si). This aims at increasing the wire width of the vertical scan lines (Si−1 to Si+1) connected to the horizontal scan line that is distant from the scan driver 20, reducing resistance, and minimizing the RC delay since the scan signal transmitted through the vertical scan lines is reduced by resistance of the vertical scan lines.

According to an exemplary embodiment, the first horizontal scan line SL1 is connected to the first vertical scan line S1, and the n-th substantially horizontal scan line (SLn) is connected to the n-th substantially vertical scan line (Sn) so the width of the vertical scan line (S1-Sn) may be increased in the horizontal direction.

Further, the vertical scan line connected to at least one horizontal scan line may not extend for the length of the display panel. For example, the first vertical scan line S1 connected to the first horizontal scan line SL1 does not substantially extend past the first horizontal scan line SL1 and stops before the second horizontal scan line SL2. A vertical scan line connected to at least one horizontal scan line may extend in the vertical direction. The horizontal scan lines (SL1 to SLn) and the vertical scan lines (S1 to Sn) are formed in a direction in which they cross each other and are substantially perpendicular.

A display unit according to a second exemplary embodiment will now be described.

An exemplary embodiment includes a display unit according to a first example of a second exemplary embodiment. A configuration of a pixel generally corresponds to the description provided with reference to FIG. 2 so no detailed description will be provided.

The signal line includes horizontal scan lines for transmitting a scan signal to the pixel, vertical scan lines for transmitting a scan signal to the horizontal scan lines, and data lines crossing the horizontal scan line and transmitting a data signal.

The vertical scan lines are connected to the horizontal scan line through a corresponding connection point from among a plurality of connection points.

The vertical scan lines may be formed to have a substantially increasing width as the distance between the horizontal scan line and the scan driver increases. As the vertical scan lines become longer, the wire width of the vertical scan lines is increased.

For example, a width of the i-th vertical scan line is formed to be greater than a width of the (i−1)-th vertical scan line. A width of the (i+1)-th vertical scan line is formed to be greater than a width of the i-th vertical scan line. The increased wire width of the vertical scan line connected to the horizontal scan line that is distant from the scan driver, reduces resistance, and minimizes the RC delay since the resistance of the vertical scan lines is reduced.

An exemplary embodiment includes a display unit according to a second example of a second exemplary embodiment.

A configuration of a pixel generally corresponds to the description provided with reference to FIG. 3 so no detailed description will be provided.

The signal line includes horizontal scan lines for transmitting a scan signal to the pixel, vertical scan lines for transmitting a scan signal to the horizontal scan lines, and data lines crossing the horizontal scan line and transmitting a data signal.

The vertical scan lines are connected to the horizontal scan lines through a corresponding connection point from among a plurality of connection points.

The vertical scan lines may be formed to have a substantially increasing width when connected to the horizontal scan line that is distant from the scan driver. For example, a width of the i-th vertical scan line is greater than a width of the (i−1)-th vertical scan line. A width of the (i+1)-th vertical scan line is greater than a width of the i-th vertical scan line. This aims at increasing the wire width of the vertical scan lines connected to the horizontal scan line that is distant from the scan driver, reducing resistance, and minimizing the RC delay since the scan signal transmitted through the vertical scan lines is reduced by resistance of the vertical scan lines.

In the above-described exemplary embodiments, no driving circuit may be disposed on the right or left of the display unit 10 so the exemplary embodiments may reduce the bezel region. Further, in the exemplary embodiments, the wire thickness of the scan line is formed to be different according to the distance from the scan driver 20 so the RC delay of transmission of the scan signal is reduced. Accordingly, the luminance of the panel may become substantially uniform.

The organic light emitting device including a switching transistor, a driving transistor, a capacitor, and an organic light emitting diode, and the liquid crystal display including a switching transistor, a liquid crystal capacitor, and a storage capacitor have been described, and the exemplary embodiment may be applied to the organic light emitting device and the liquid crystal display for forming a driving circuit on the first side of the panel or forming the driving circuit on the first side and the second side facing the first side.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a substrate;
a plurality of first signal lines extending in a first direction on the substrate; and
a plurality of second signal lines extending in a second direction crossing the first direction and each first signal line of the plurality of first signal lines is connected to a respective second signal line of the plurality of second signal lines,
wherein wire widths of the first signal lines vary based on a length of the connected second signal lines.

2. The display device of claim 1, wherein
wire widths of the first signal lines are increased when the connected second signal lines become longer.

3. The display device of claim 1, wherein
wire widths of the second signal lines are increased when the second signal lines become longer.

4. The display device of claim 1, wherein
wire widths of the first signal lines and the second signal lines are between 2.5 μm and 5.5 μm.

5. The display device of claim 1, further comprising
a scan driver formed on a first side of the substrate and connected to the second signal lines;
the scan driver supplies a scan signal to the second signal lines.

6. The display device of claim 1, wherein
each second signal line of the plurality of second signal lines is connected to a different first signal line from among the plurality of first signal lines; and
the length of each second signal line of the plurality of second signal lines is the distance from the scan driver to the respective connected first signal line from among the plurality of first signal lines.

7. The display device of claim 1, wherein
the first signal lines and the second signal lines are formed on a layer.

8. The display device of claim 5, further comprising:
a plurality of third signal lines extend in the second direction on the substrate;
a data driver on the first side and connected to the third signal lines; and
the data driver supplies a data signal to the third signal lines.

9. The display device of claim 8, further comprising
each pixel of a plurality of pixels connected to the first signal line of the plurality of first signal lines and the third signal line of the plurality of the third signal lines.

10. A display device comprising:
a display panel;
a driver on a side of the display panel;
a plurality of first signal lines in a first direction, wherein a first end of each of the plurality of first signal lines are connected to the driver;
a plurality of second signal lines in a second direction, wherein each second signal line of the plurality of second signal lines are connected to a respective second end of each of the plurality of first signal lines; and
wherein a wire width of each of the plurality of first signal lines increases based on a length of each of the plurality of first signal lines.

11. The display device of claim 10, wherein the first direction and the second direction are perpendicular.

12. The display device of claim 10, wherein the length of each of the plurality of first signal lines is a distance from the driver to the respective connected first signal line from among the plurality of first signal lines.

13. The display device of claim 10, further comprising a data driver; and
a plurality of data lines connected to the data driver arranged along the second direction.

14. The display device of claim 13, further comprising a plurality of pixels. wherein each pixel is connected to a respective second signal line and a data line.

15. A display device comprising:
a display panel;
a driver on a side of the display panel;
a plurality of first signal lines in a first direction, wherein a first end of each of the plurality of first signal lines are connected to the driver;
a plurality of second signal lines in a second direction, wherein each second signal line of the plurality of second signal lines are connected to a respective second end of each of the plurality of first signal lines; and
wherein a wire width of each of the plurality of second signal lines increases based on a length of each of the plurality of first signal lines.

16. The display device of claim 15, wherein the first direction and the second direction are perpendicular.

17. The display device of claim 15, wherein the length of each of the plurality of first signal lines is a distance from the driver to the respective connected first signal line from among the plurality of first signal lines.

18. The display device of claim 15, further comprising a data driver; and
a plurality of data lines connected to the data driver arranged along the second direction.

19. The display device of claim 18, further comprising a plurality of pixels. wherein each pixel is connected to a respective second signal line and a data line.
